(19) United States
(12) Patent Application Publication
(10) Pub. No.: US 2010/0159728 A1
(43) Pub. Date: Jun. 24, 2010

(54) ELECTRICAL CONNECTOR WITH A ROTATING METAL SHELL

(75) Inventors: HONG-FANG WANG, Kunshan (CN); MING ZHANG, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/607,084

(22) Filed: Oct. 28, 2009

(30) Foreign Application Priority Data
Dec. 23, 2008 (CN) 200810306457.X

(51) Int. Cl. H01R 13/62

(52) U.S. Cl. 439/312

(57) ABSTRACT

An electrical connector includes: an insulating housing defining a mounting face for being mounted on a PCB and a pair of engaging portions at two opposite ends of the insulating housing; a number of contacts retained in the insulating housing; a metal shell assembled on the insulating housing along an assembly direction slanting to the mounting face, the metal shell having a locking portion with a gap through which the engaging portion is inserted in the locking portion and a stopper portion. The stopper portion exceeds the mounting face when the metal shell assembled on the insulating housing along the assembly direction before the electrical connector is mounted on the PCB, while the stopper portion is pressed by the PCB to offset the assembly direction when the electrical connector is mounted on the PCB so as to prevent the engaging portion from deflecting from the locking portion through the gap.

### BACKGROUND OF THE INVENTION

1. Field of the Invention

The present invention relates to an electrical connector having a rotating metal shell and mounted on a PCB.

2. Description of Related Art

An electrical connector used in an electronic device usually has a shielding member to protect the electrical connector for EMI. As disclosed in TW Pat. No. 326255, an electrical connector includes a longitudinal insulating housing, a plurality of contacts retained in said insulating housing to be mounted on a PCB and a longitudinal shielding member covering on said insulating housing. The shielding member includes a bottom shell and a top shell rotatable engaging with said bottom shell between an open position and a closed position. Said top shell has a first engaging portion engaging with said bottom shell and a second engaging portion engaging with insulating housing after the top shell rotates to the closed position. Said insulating housing is assembled into a retaining space defined by said bottom shell and said top shell therebetween. And then the top shell rotates to the closed position to securely engage with the insulating housing by the second engaging portion. However, said top shell and said bottom shell has a complicated structure and should engages with each other before the insulating housing is assembled into the retaining space, which reduce the efficiency of the assembly procedure.

So it is necessary to provide a new electrical connector to solve the problems above.

### SUMMARY OF THE INVENTION

Accordingly, it is an object of the present invention to provide an electrical connector with a rotatable metal shell which is conveniently assembled.

In order to achieve above-mentioned object, an electrical connector is provided and comprises: an insulating housing defining a mounting face for being mounted on a PCB and a pair of engaging portions at two opposite ends of the insulating housing; a plurality of contacts retained in said insulating housing; a metal shell assembled on the insulating housing along an assembly direction slanting to the mounting face, said metal shell having a locking portion with a gap through which the engaging portion is inserted in the locking portion and a stopper portion. The stopper portion exceeds the mounting face when the metal shell assembled on the insulating housing along said assembly direction before the electrical connector is mounted on the PCB, while the stopper portion is pressed by the PCB to offset the assembly direction when the electrical connector is mounted on the PCB so as to prevent the engaging portion from deflecting from the locking portion through the gap.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical connector in accordance with the present invention;

FIG. 2 is an exploded perspective view of the electrical connector of FIG. 1;

FIG. 3 is a side view of the electrical connector of FIG. 1 during the second shell is assembled on the insulating housing;

FIG. 4 is a side view of the electrical connector of FIG. 3 after the second shell is assembled on the insulating housing along an assembly direction A;

FIG. 5. is a perspective view of the electrical connector of FIG. 4 after mounted on a PCB with the second shell on a closed position; and

FIG. 6 is a perspective view of the electrical connector of FIG. 5 when the second shell rotates to an open position.

### DETAILED DESCRIPTION OF THE INVENTION

The present invention shall be discussed hereinafter in terms of a preferred embodiment illustrated in the accompanying drawings. In the following description, numerous specific details are set forth in order for the reader hereof to gain a thorough understanding of the present invention. It will be obvious, however, to those skilled in the art that certain well-know elements may not be shown in detail in order to unnecessarily obscure the present invention.

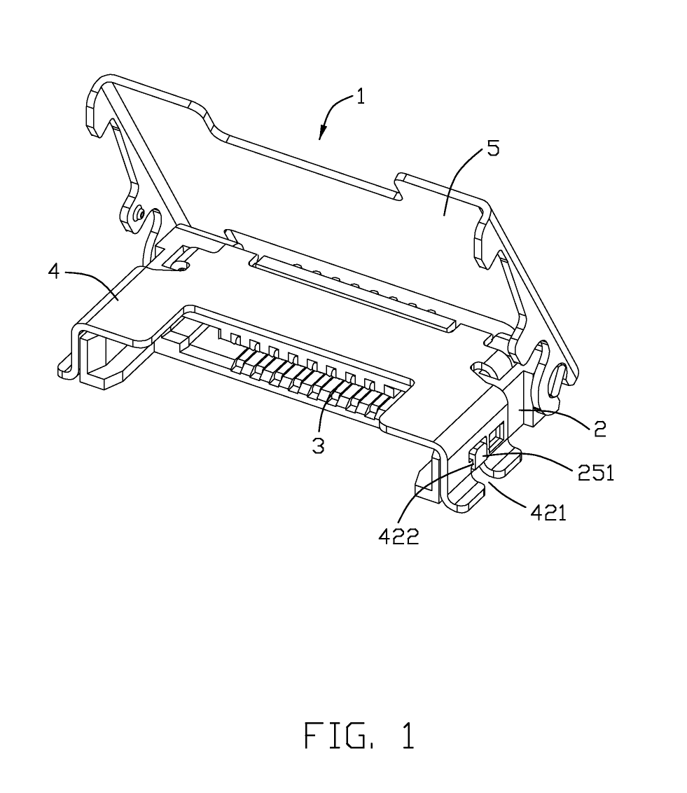

Referring to FIGS. 1 to 6, an electrical connector 1 with a mounting face M for being electrically mounted on a PCB 6 includes an insulating housing 2, a plurality of contacts 3, a first shell 4 assembled on the insulating housing 2 and a second shell 5 covered on said insulating housing 2 and first shell 4 to rotate between an open position and a closed position. The electrical connector 1 mates with a counterpart connector along a mating direction.

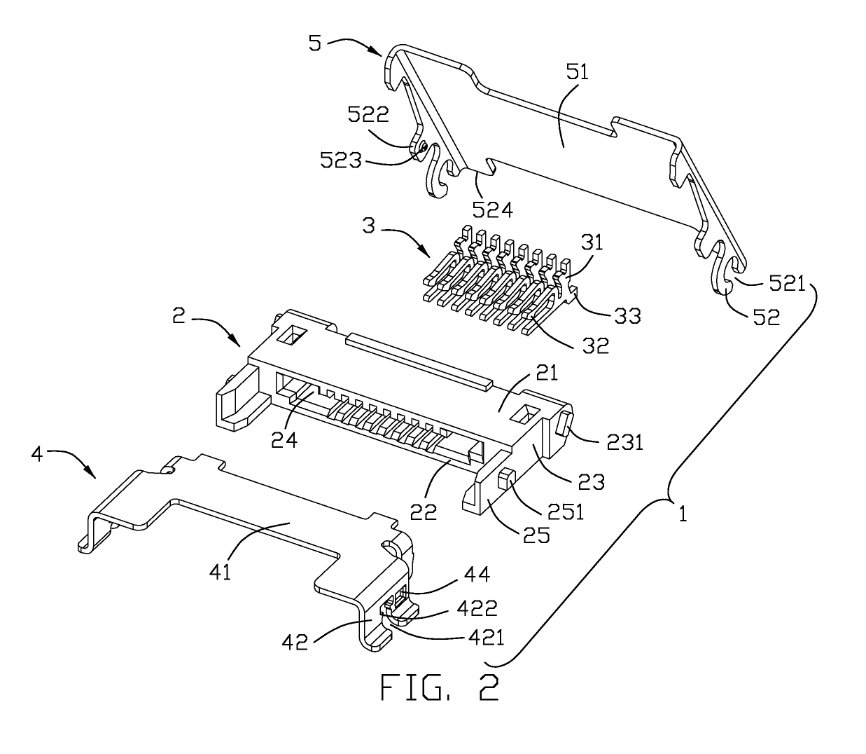

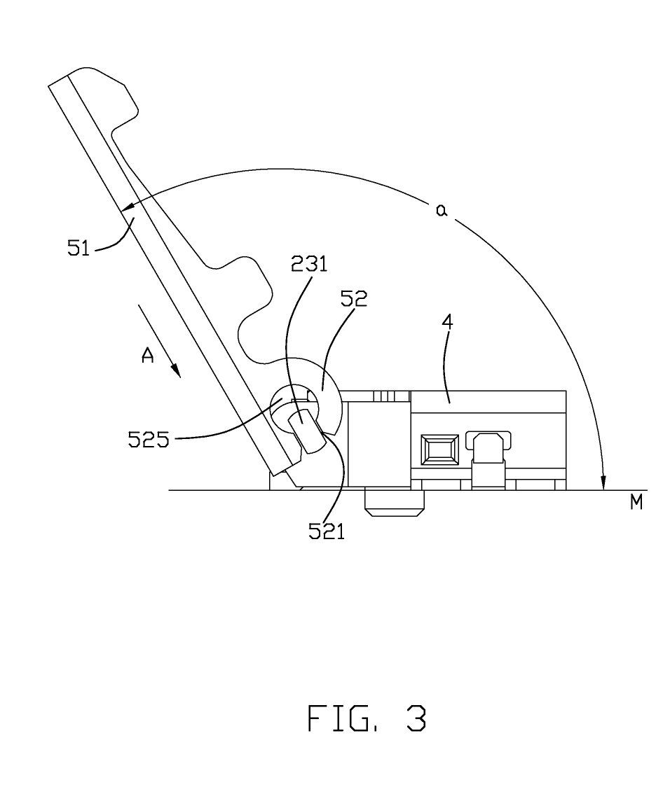

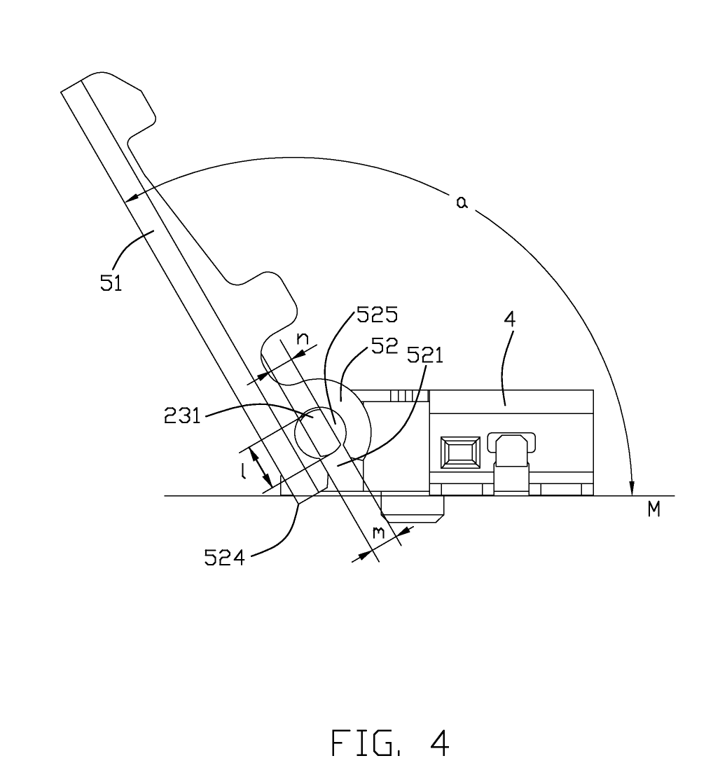

In FIG. 2 and FIG. 3, said insulating housing 2 includes a top wall 21, a bottom wall 22 and a pair of sidewalls 23 connected with the top wall 21 and the bottom wall 22 to commonly define a longitudinal mating groove 24 thereamong for receiving a counterpart connector. The bottom wall 22 and the top wall 21 defines a plurality of passageways facing the mating groove 24 to receive the contacts 3. The sidewalls 23 define a pair of latches 25 extending horizontally along the mating direction to guide the counterpart connector and engage with the first shell 4. Said sidewall 23 has an engaging portion 231 protruding outwardly from an outer surface thereon to engage with the second shell 5. Said engaging portion 231 is of a slantwise rectangle rib with a traverse width n and a length 1 (as shown in FIG. 4) to make an angle with the horizontal PCB 6. Said latch 25 has a protruding block 251 projecting from an outer surface thereon to engage with the shell member 4.

In FIG. 2, said contacts 3 are retained in the passageways of the insulating housing 1 and include a retaining beam 31, a contacting beam 32 extending into the receiving groove 24 and a soldering leg 33 horizontally extending from said retaining beam 31 to be soldered on the PCB 6. The contacts 2 are assembled into the insulating housing 2 from backwards.

The first shell 4 is assembled on the insulating housing 1 to cover the top wall 21 and the latches 25 from a top side and includes a horizontal plate 41 and a pair of mounting flanges 42 extending downwardly from two ends of said horizontal plate 41. Said mounting flange 42 defines a retaining slot 421 receiving said protruding block 251 of the latch 25 and a pair of retaining tabs 422 extending into the retaining slot 421 to engage with the protruding block 251.

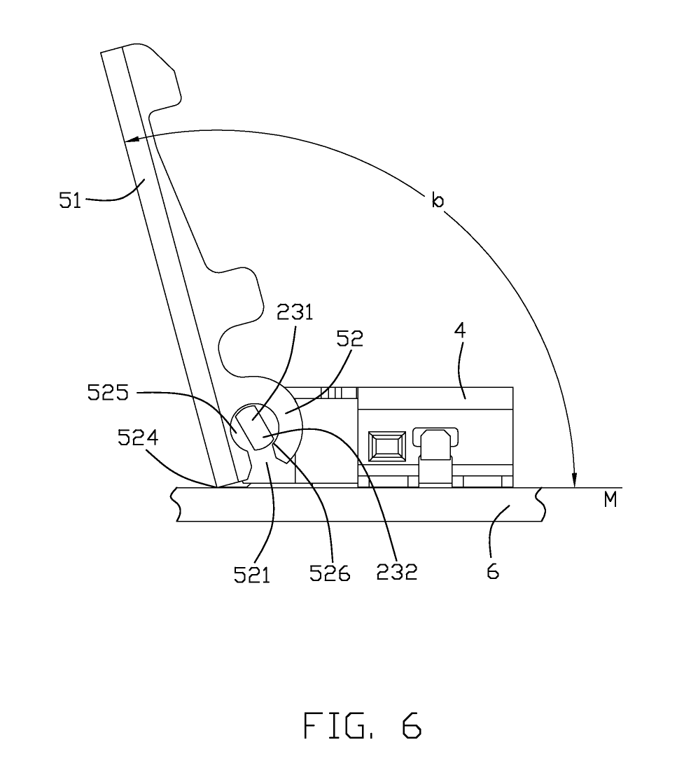

As referring to FIGS. 2 and 4, the second shell 5 is made of a metal plate and has a base portion 51 covering on the insulating housing 2 and said first shell 4 and a pair of locking portions 52 downwardly extending from two ends of said base portion 51. Said locking portion 52 of a hook shape defines a retaining aperture 525 with a gap 521 to rotatably retain the engaging portion 231. The gap 521 has a width m which is appreciably wider than the traverse width n of the engaging portion 231 to allow the engaging portion 231 to engage into the retaining aperture 525 through the gap 521 along an assembly direction A as shown in FIG. 3. The retaining aperture 525 has a circle inner surface 526 as shown in FIG. 6 so that the engaging portion 231 can rotatably engage with the retaining aperture 525 of the locking portion 52 while the second shell 5 rotates between the open position and the closed position. Said second shell 5 further includes a pair of locking tabs 522 with a locking dimple 523 extending inwardly from an inner surface thereon to engage with notches 44 of the first shell 4 after the second shell 5 rotates to the closed position. A pair of back stopper portions 524 of the second shell 5 are formed on said base portion 51 adjacent to said locking portions 52 in order to abut against the PCB 6 when the second shell 5 rotates to the closed position.

As shown in FIGS. 3 and 4, the second shell 5 is assembled onto the insulating housing 2 along an assembly direction A which defines an obtuse angle of a to the mounting face M of the electrical connector 1. The gap 521 of the locking portion 52 correspondingly faces to the engaging portion 231 so that the engaging portion 231 of the insulating housing 2 can smoothly engage into the retaining aperture 525 through the gap 521 and rotatably engage with the locking portion 52. As referring to FIG. 4, after the second shell 5 is assembled on the insulating housing 2, said stopper portions 524 of the second shell 5 downwardly exceed the mounting face M before the electrical connector 1 mounted on the PCB 6.

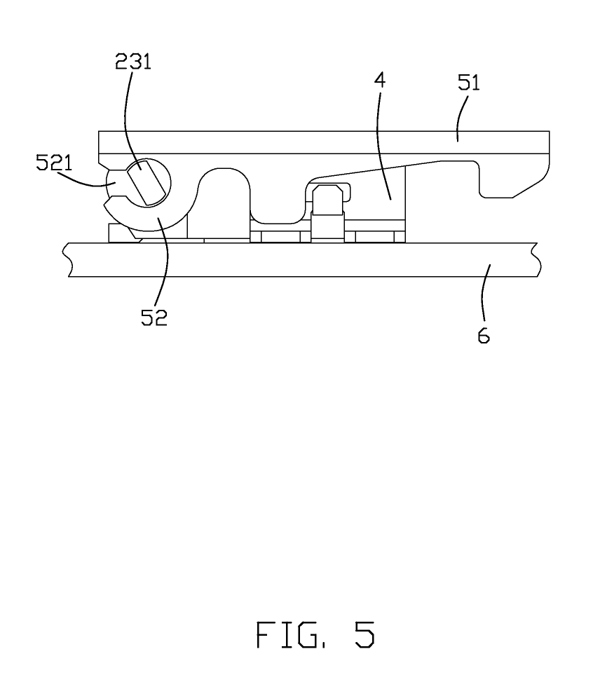

As a result, after the second shell 5 is assembled on the insulating housing, said electrical connector 1 is mounted on the PCB 6 by the mounting face M, said PCB 6 upwardly abuts against said stopper portions 524 of the second shell 5 and generates a clockwise torque on the second shell 5. In FIG. 6, said locking portion 52 of the second shell 5 rotates clockwise around the engaging portion 231 and drives the second shell 5 clockwise offset from the assembly direction A to change the angle a into a smaller angle of b as shown in FIG. 6. Said angle of b defines the open position of the second shell 5. Meanwhile, the gap 521 rotates clockwise and offsets from the engaging portion 231 so that the engaging portion 231 cannot face to the gap 521, which makes the engaging portion 231 fail to disengage out from the retaining aperture 525 through said gap 521. As referring to FIG. 6, one end 232 of said engaging portion 231 abuts against by the inner surface 526 of the retaining aperture 525 and fails to move out from the retaining aperture 525. Said length 1 of the engaging portion 231 is much wider than the width m of the gap 521 so that the engaging portion 231 can not disengage out from the gap 521 during the second shell 5 rotates between the open position and the closed position. After the second shell 5 rotates to the closed position, as shown in FIG. 5, said engaging portion 231 also fails to disengage from the gap 521 which provides a stable engagement between the second shell 5 and the insulating housing 2. As a result, the second shell 5 can be easily assembled onto the insulating housing 2 and securely engages with the insulating housing 2 once after the electrical connector 1 assembled on the PCB 6.

As well-known to a skilled person in the art, said engaging portion 231 can also be formed on said second shell 5 while the locking portion 52 and the retaining aperture 525 are formed on the insulating housing 2, which is also an embodiment of the present invention.

However, while the preferred embodiment of the invention have been shown and described, it will apparent to those skilled in the art that changes and modifications may be made therein without departing from the spirit of the invention, the scope of which is defined by the appended claims.

What is claimed is:

1. An electrical connector comprising:
an insulating housing defining a mounting face for being mounted on a PCB and a pair of engaging portions at two opposite ends of the insulating housing;
a plurality of contacts retained in said insulating housing;
a metal shell assembled on the insulating housing along an assembly direction slanting to the mounting face, said metal shell having a locking portion with a gap through which the engaging portion is inserted in the locking portion and a stopper portion; wherein
said stopper portion exceeds the mounting face when the metal shell is assembled on the insulating housing along said assembly direction before the electrical connector is mounted on the PCB, while the stopper portion is pressed by the PCB to offset the assembly direction when the electrical connector is mounted on the PCB so as to prevent the engaging portion from deflecting from the locking portion through the gap.

2. The electrical connector as claimed in claim 1, wherein said locking portion is of a hook shape, said gap faces to the engaging portion during assembling the metal shell onto the insulating housing.

3. The electrical connector as claimed in claim 1, wherein said engaging portion of the insulating housing is a slantwise rectangle rib with a traverse width narrower than said gap of the locking portion.

4. The electrical connector as claimed in claim 2, wherein the gap always offsets from the engaging portion during rotating the metal shell between an open position and a closed position after the electrical connector mounted on the PCB.

5. The electrical connector as claimed in claim 4, wherein said locking portion of the metal shell engages with the engaging portion of the insulating housing along the assembly direction, and said assembly direction defines a first angle to said mounting face.

6. The electrical connector as claimed in claim 5, wherein said open position of the metal shell offsets from said assembly direction after the electrical connector is mounted on the PCB.

7. The electrical connector as claimed in claim 1, wherein said locking portion defines a retaining aperture with a circular inner surface to engage with said engaging portion of the insulating housing during rotating the metal shell between an open position and a closed position.

8. The electrical connector as claimed in claim 7, wherein further including another shell covering on said insulating housing and located under said metal shell.

9. The electrical connector as claimed in claim 8, wherein said engaging portion is formed on an outer surface of the sidewall.

10. An electrical connector comprising:
an insulating housing defining a mating groove extending a longitudinal direction and surrounded by a pair of walls;
a plurality of contacts arranged in the housing along the longitudinal direction;
a first metal shell covering on one of said pair of walls along the longitudinal direction; and
a second metal shell covering on the first metal shell along the longitudinal direction.

11. The electrical connector as claimed in claim 10, wherein the second metal shell is pivotably supported at one side of the connector opposite a mating opening of the mating groove.

12. The electrical connector as claimed in claim 11, wherein one of the second metal shell and the housing defines a rib and another one of the second metal shell and the housing defines an aperture with an opening through which the rib is inserted into the aperture, and the second metal shell rotates around the rib.

13. The electrical connector as claimed in claim 12, wherein the second metal shell defines a stopper portion projecting beyond a mounting face of the housing by which the connector is mounted on a printed circuit board under a condition that the rib is aligned with the opening of the aperture.

14. The electrical connector as claimed in claim 12, wherein the opening is slight large than the rib.

15. An electrical connector assembly comprising:
an insulative housing defining a mating port thereof;
a plurality of contacts disposed in the housing with contacting sections extending into the mating port;
a polarized engaging portion located around one end of the housing;
a cover pivotally mounted above the housing, said cover including a locking portion pivotally and latchably engaged with the engaging portion in a circumferential manner except at one specific diametrical position/direction compliant with a polarization position of the engaging portion where the locking portion of the cover and the engaging potion are no longer locked to each other; wherein
a stopper portion is formed on the cover and has an abutment section located below a bottom face of the housing when said cover is located at said specific diametrical position/direction relative to the housing so as to allow said cover to be assembled to the housing when the housing is essentially in a free standing manner, while said abutment section is urged by an upper surface of the printed circuit board after the housing is mounted to a printed circuit board, thus resulting in a backward rotation of the cover from said specific diametrical position/direction to another one whereby said engaging portion and said locking portion are locked to each other in said circumferential manner.

16. The electrical connector assembly as claimed in claim 15, wherein said locking portion defines a ring configuration with a gap thereof, while said engaging portion defines a rectangular cross-section and adapted to be radially inserted into a central opening in said ring configuration via said gap only when said cover is located at the specific position/direction relative to the housing.

17. The electrical connector assembly as claimed in claim 16, wherein said rectangular cross-section of said engaging portion extends in an oblique direction which is same with said specific position/direction of the cover relative to the housing.

18. The electrical connector assembly as claimed in claim 15, wherein said cover defines a closed position where the cover is locked and essentially fully shields the housing in a vertical direction, and an open position relative to the housing wherein said cover is essentially fully uncover the housing in said vertical direction, under condition that said open position and said closed position are spaced from each other with an angle larger than 90 degrees with a pivotal range of said cover.

19. The electrical connector assembly as claimed in claim 18, wherein said specific position of the cover is closer to said opening position of the cover while with an other angle larger than said angle with regard to the closed position.

20. The electrical connector assembly as claimed in claim 15, wherein a metallic shell is assembled to an upper face of the housing and located between the cover and the housing when said cover is located in the closed position.
